(19) United States
(12) Patent Application Publication
(10) Pub. No.: US 2006/0139449 A1
(43) Pub. Date: Jun. 29, 2006

(54) Wireless audio-video doorbell monitoring system

(76) Inventors: Wen-Liang Cheng, Jubei City (TW); Feng-Chi Yeh, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/019,164

(22) Filed: Dec. 23, 2004

(51) Int. Cl. H04N 7/18; H04N 9/47

(52) U.S. Cl. 348/61

(57) ABSTRACT

The present invention pertains to a wireless audio-video doorbell monitoring system, wherein a portable monitoring device administrates a doorbell device and detective devices. After initiation, the monitoring device calls other nearby devices to form a wireless network via a wireless broadcasting way, and then the monitoring device administrates each device to perform the doorbell or detection function. Via the automatic setup and simple operating interface, the present invention enables a general family to be free from a complex operational procedure. In the present invention, the detective device can sense the image and sound of the monitored regions, which is sent to a display panel and a speaker of the monitoring device without a time lag. Accordingly, the present invention provides an instantaneously-displaying and easy-operated wireless audio-video doorbell monitoring system, which is easy installed, automatically set up, highly securing, able to reduce the power consumption efficiently and suitable for a general family usage.

### BACKGROUND OF THE INVENTION

(a) Field of the Invention

The present invention relates to a doorbell monitoring system, particularly to a wireless digital audio-video doorbell monitoring system for a general family usage.

(b) Description of Related Art

A monitoring system can provide people with a lot of fortune security and life safety. Owing to the progressive advance of electronic technology, the electronic equipment, which was pretty expensive before, becomes a consumptive electronic product, and the monitoring system, which was used only by large-scale or military organizations originally, grows popular in general families, and thus now a general family can afford the security system, which is not only economic but also easy to operate.

A conventional doorbell monitoring system usually comprises an outdoor device and an indoor device interconnected with each other via a wire. The outdoor device can only transfer audio-video signal to the indoor device, however, cannot detect the surroundings of a house, and thus cannot guard a family's safety. Further, as it needs an additional wiring, it's hard to install the conventional wired monitoring device.

A conventional monitoring system, such as “Digital Intelligent Monitoring System” of Taiwan Patent No. 132510, is constructed via interconnecting a digital audio-video server and a computer in a distal node by a network. As the adoption of a computer and a TCP/IP network, the structure of the “Digital Intelligent Monitoring System” is complex, and the setup of the system needs a professional person. Thus, the building cost thereof is raised, and a general family cannot afford its price and the cost of maintenance.

Owing to those described above, the present invention provides a wireless audio-video doorbell monitoring system in order to solve the aforementioned problems of the conventional technology.

### SUMMARY OF THE PRESENT INVENTION

The primary objective of the present invention is to provide a wireless doorbell audio-video monitoring system, wherein outdoor devices are connected with a monitoring device wirelessly in order that the disposal of each device wound not be restricted by the configuration of the surroundings and the monitoring device can be disposed at any indoor space freely.

Another objective of the present invention is to integrate each device in a wireless way with an automatic linking in order that the connecting interface of each device would be no more necessary and the consumer can avoid the difficulty of installing and maintenance.

Yet another objective of the present invention is to utilize a built-in passive infrared reflective sensor to automatically switch cameras and microphones on just when some event is happening without necessity of powering the machine all day long, and to avoid an unnecessary machine's depreciation and power consumption.

According to one aspect of the present invention, a wireless audio-video doorbell monitoring system of the present invention is designed to be that a doorbell device, detective devices and a monitoring device are integrated into an independent network via a wireless way in order to detect moving persons or objects and wirelessly transfer image and sound to the monitoring device and the house owner and a visitor can be interlinked via the doorbell and the house owner can also identify the visitor via the image, and the house safety is thus secured.

Via the attached drawings and the embodiments of the present invention described below, the objectives, technical contents, characteristics and accomplishments of the present invention are to be more easily understood.

### BRIEF DESCRIPTION OF THE DRAWINGS

FIG. 1 is a schematic block diagram of the network architecture according to one aspect of the present invention.

FIG. 2 is a schematic block diagram of the doorbell device structure according to one aspect of the present invention.

FIG. 3 is a schematic diagram of the operating panel of the doorbell device according to one embodiment of the present invention.

FIG. 4 is a schematic block diagram the detective device structure according to one aspect of the present invention.

FIG. 5 is a schematic diagram of the operating panel of the detective device according to one embodiment of the present invention.

FIG. 6 is a schematic block diagram of the monitoring device structure according to one aspect of the present invention.

FIG. 7 is a schematic diagram of the operating panel of the monitoring device according to one embodiment of the present invention.

FIG. 8 is a schematic diagram of the state-machine of each device according to one aspect of the present invention.

### LIST OF REFERENCE NUMERALS

1 monitoring system
2 doorbell device
4 detective devices
6 monitoring device
200 multi-media processor
202 RF transceiver module
204 audio/voice CODEC
206 doorbell
208 relay
210 gate
212 memory
214 CMOS sensor
216 microphone
218 speaker
222 power indicator
225 link indicator
228 group number
229 identify number
400 multi-media processor
402 RF transceiver module
404 audio/voice CODEC
412 memory
414 CMOS sensor
416 microphone
420 PIR sensor
422 power indicator
425 link indicator
428 group number
429 identify number
600 multi-media processor
602 RF transceiver module
604 audio/voice CODEC
607 display panel
609 open gate button
612 memory
615 select keys
616 microphone
618 speaker
622 power indicator
624 conversation button
625 link indicators
628 group number

### REFERRED EMBODIMENTS OF THE PRESENT INVENTION

The present invention utilizes a wireless network as an interlinking means of a monitoring system and a digital signal as transmission media of audio-video data. The present invention can solve the drawback of the incapability of identifying the image of a visitor in the conventional doorbell and avoid the inconvenience resulting from the complexity of the system.

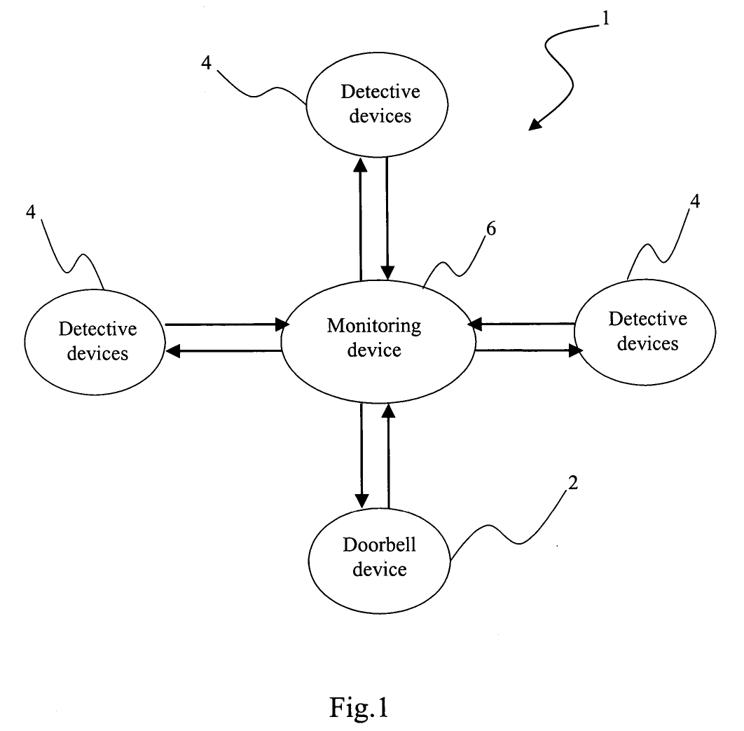

Referring to FIG. 1 a schematic block diagram of the network architecture according to one aspect of the present invention, a monitoring system 1 comprises: a doorbell device 2, three detective devices 4, and a monitoring device 6, wherein the doorbell 2 is usually positioned at the entrance of the monitored region; the devices of the monitoring system 1 are interlinked via a wireless network, and the doorbell device 2 and detective devices 4 are administrated by the monitoring device 6; the frequency utilized by the wireless network is a 2.4 GHz ISM (Industry, Science and Medicine) frequency band.

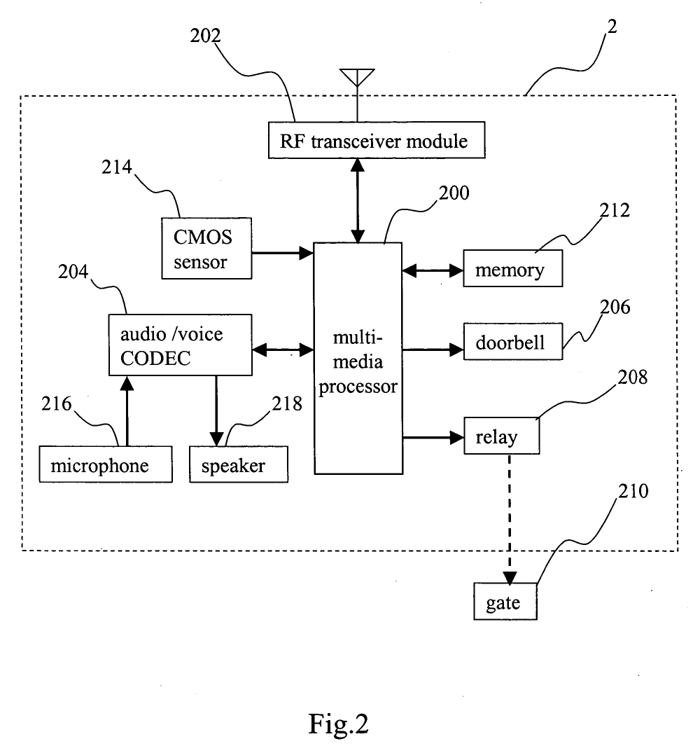

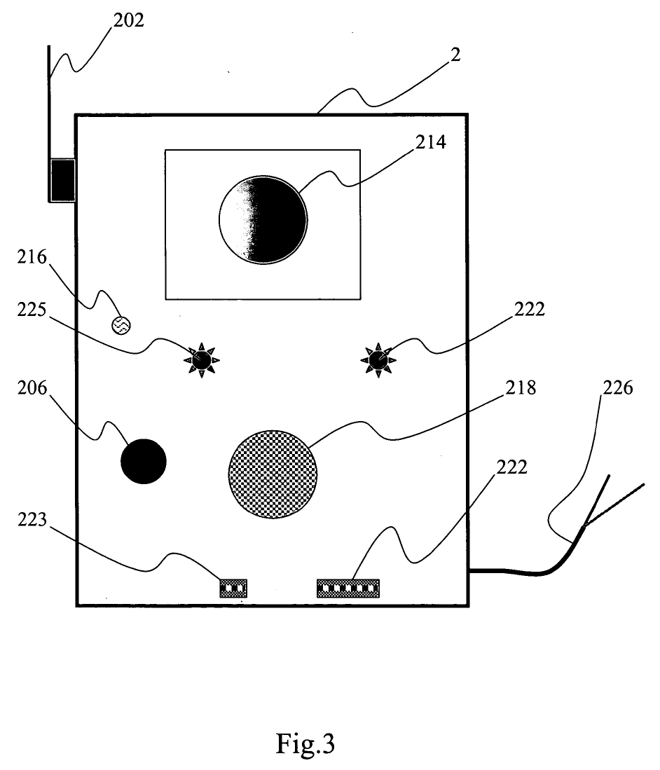

Referring to FIG. 2 a schematic block diagram of the doorbell device structure according to one aspect of the present invention and FIG. 3 a schematic diagram of the operating panel of the doorbell device according to one embodiment of the present invention, the doorbell device 2 includes a doorbell 206, which generates a bell ring as a visitor's request signal for a conversation with the house owner, an CMOS sensor 214, which takes the images of the visitor, a microphone 216 and speaker 218, which sends and receives a sound signal, an RF transceiver module 202, which receives and transmits wireless signal, an audio/voice CODEC 204, which encodes an analog signal and decodes a digital signal of sound, an relay 208, which controls the switching of a gate 210, and a multi-media processor 200, wherein the multi-media processor 200 connects with the doorbell 206, CMOS sensor 214, relay 208, RF transceiver module 202 and audio/voice CODEC 204, and the multi-media processor 200 processes the digital signal of image and sound, and a memory 212 connects with the multi-media processor 200 to store the programs and data of the multi-media processor 200. The operating panel of the doorbell device 2 comprises: a power indicator 222, which indicates the state of power supply, a link indicator 225, which indicates the link state of the wireless, a group number 228 and an identify number 229.

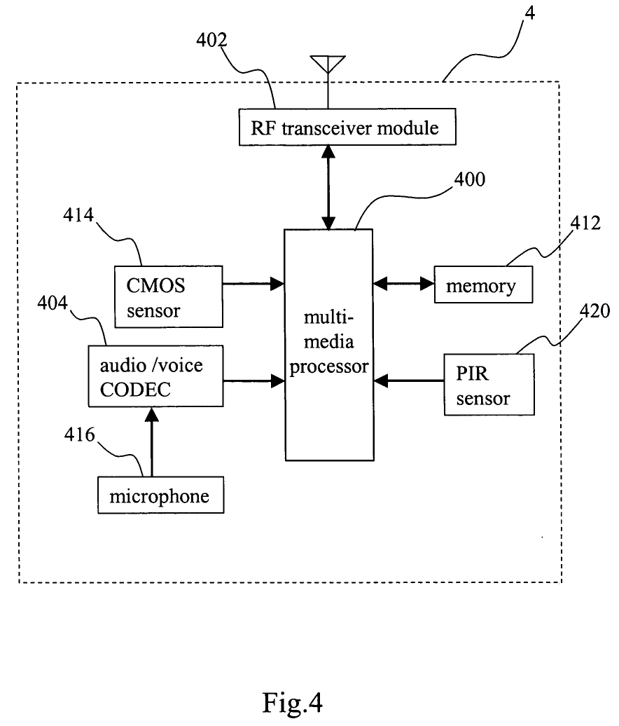

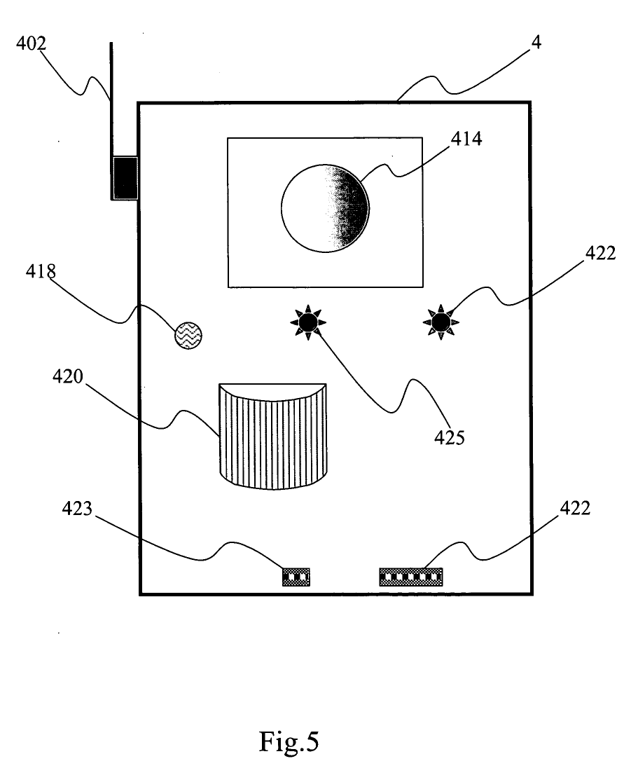

Referring to FIG. 4 a schematic block diagram of the detective device structure according to one aspect of the present invention and FIG. 5 a schematic diagram of the operating panel of the detective device according to one embodiment of the present invention, the detective device 4 comprises: a microphone 416, which receives a sound signal, a CMOS sensor 414, which takes the images of the surroundings, a PIR sensor 420, which can detects the movement of objects in the surroundings, an RF transceiver module 402, an audio/voice CODEC 404 and a multi-media processor 400, wherein the multi-media processor 400 connects with the CMOS sensor 414, PIR sensor 420, RF transceiver module 402 and audio/voice CODEC 404, and the multi-media processor 400 processes the digital signal of image and sound, and a memory 412 connects with the multi-media processor 400 to store the programs and data of the multi-media processor 400. The operating panel of the detective device 4 comprises: a power indicator 422, which indicates the state of power supply, a link indicator 425, which indicates the link state of the wireless, a group number 428 and an identify number 429.

The aforementioned CMOS sensors 214,414 are CMOS (Complementary Metal Oxide Semiconductor) image sensor, and the PIR sensor 420 is a Passive Infrared Reflective sensor.

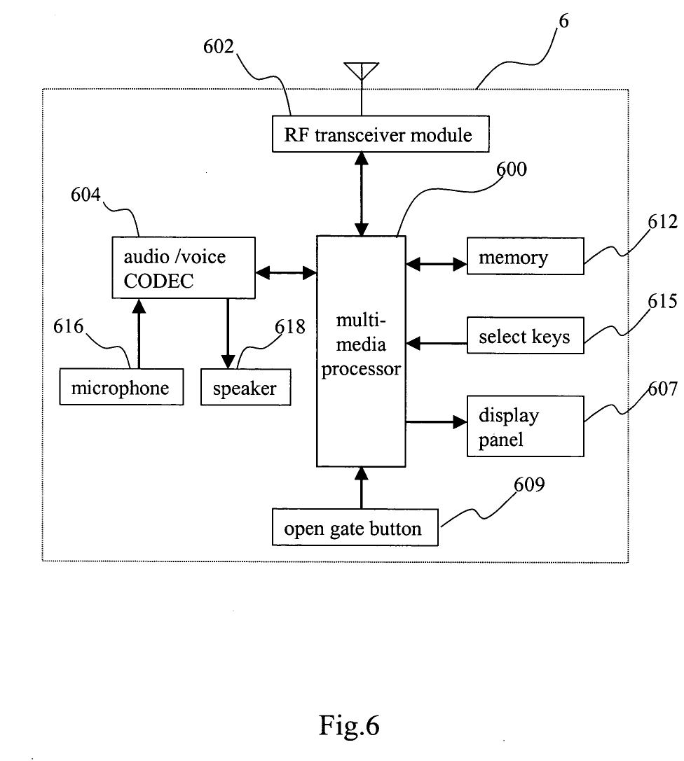

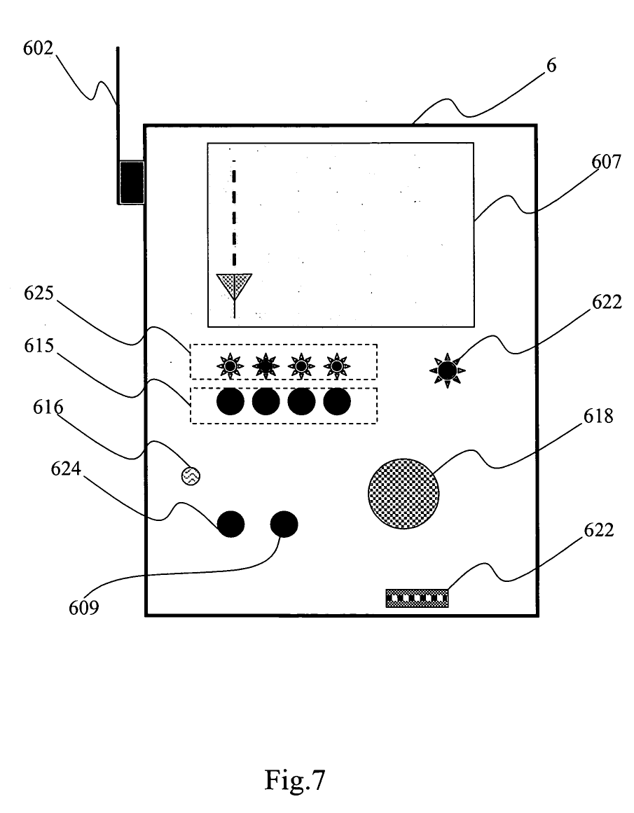

Referring to FIG. 6 a schematic block diagram of the monitoring device structure according to one aspect of the present invention and FIG. 7 a schematic diagram of the operating panel of the monitoring device according to one embodiment of the present invention, the monitoring device 6 comprises: a plurality of select keys 615, via which the house owner can selects which one of the detective devices 4 and the doorbell device 2 to connect with the monitoring device 6, a display panel 607, which displays the image of the monitored region, a microphone 616, a speaker 618, an RF transceiver module 602, an audio/voice CODEC 604 and a multi-media processor 600, wherein the multi-media processor 600 connects with the RF transceiver module 602, audio/voice CODEC 604, select keys 615 and display panel 607, and the multi-media processor 600 processes the digital signal of image and sound, and a memory 612 connects with the multi-media processor 600 to store the application programs and data of the multi-media processor 600. The operating panel of the monitoring device 6 comprises: an open gate button 609, which sends an open signal via the multi-media processor 600 to the doorbell device 2, a plurality of link indicators 625, which indicate the link state of the wireless link with each device, a power indicator 622 and a group number 628. The display panel 607 can be a LCD (Liquid Crystal Display) display panel, OLED (Organic Light Emitting Diode) display panel or CGSilicon (Continuous Grain Silicon) LCD display panel.

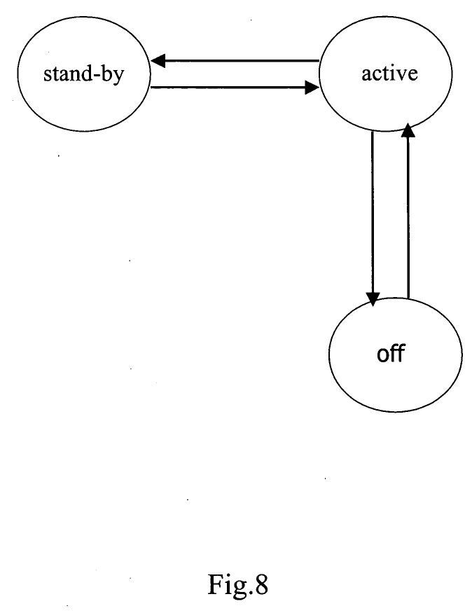

The executive procedure of the system of the present invention is described below. Referring to FIG. 8 a schematic diagram of the state-machine of each device according to one aspect of the present invention, the doorbell device 2 and the detective devices 4 are positioned at the monitored regions and powered to become active. After the monitoring device is powered to operate, a polling mechanism is initiated and the monitoring device 6 calls each of the devices and waits for its acknowledge in turn in a given frequency, such as one device/one second. Once receiving a calling, the doorbell device 2 or the detective devices 4 send responsive signals immediately to the monitoring device 6, and thus a wireless network is built, and every device starts to operate ordinarily. Once there is some event happening in the monitored regions, the doorbell device 2 or the detective device 4 will be triggered to send a signal to the monitoring device to request a link, and once the link is built, the link will continue for the duration of at least ten seconds. When a series of events happen, the event of higher priority will interrupt the link of the event of lower priority in order to link with the monitoring device 6 once the 10 seconds of at least link duration of the anterior event is over. If the events of the same priority happen in series, the posterior one can interrupt the link of the anterior one but still has to wait until the 10 seconds of at least link duration of the anterior event is over. The monitoring device 6 would not switch to next link until the 10 seconds of at least link duration of the anterior event is over. If there is no new event after the last event has been over for 3 minutes, the monitoring device 6, the doorbell device 2 and detective device 4 will come into a stand-by state in order to save the power and wait for next event's triggering. In the stand-by state, the display panel 607, the microphone 616 and speaker 618 stop operating, and the CMOS sensors 214, 414 also stop operating. The monitoring device 6 has the highest priority to control the doorbell device 2 to undertake voice communication and open the gate 210, or to control the doorbell device 2 to link with the detective device 4 in order to receive an image and sound signal.

While a visitor presses the button of the doorbell 206, a triggered signal will be sent to the RF transceiver module 202 via the multi-media processor 200, and simultaneously the CMOS sensor 214 and the microphone 216 are also triggered so that the doorbell device 2 may become active. The RF transceiver module 202 sends a wireless signal to the RF transceiver module 602 of the monitoring device 6, and then the signal is recovered to the original signal and sent to the multi-media processor 600. Once the multi-media processor 600 receives the signal, it become active and controls the display panel 607, the microphone 616, the speaker 618 and other device to prepare to link with the doorbell device 2 and sends a signal to the speaker 618 to generate a bell ring, and then sends a signal of link permission to the multi-media processor 200 of the doorbell device 2 via the original path; then the image signal of the visitor taken by the CMOS sensor 214 and the sound signal received by the microphone 216 will be compressed into a digital audio-video data by the multi-media processor 200, and the digital audio-video data will be sent to the monitoring device 6 by the RF transceiver module 202. Once the monitoring device 6 receiving the digital audio-video data, the multi-media processor 600 processes the data and sends the audio signal to the speaker 618, the video signal to the display panel 607. The house owner can press the conversation button 624 to transfer the sound signal to the speaker 218 of the doorbell device 2 to talk with the visitor. When the house owner determines to open the door, he presses the open gate button 609 to trigger the multi-media processor 600. When the multi-media processor 600 receives the triggering signal, it will send a predetermined door-opening code to the doorbell device 2 via the RF transceiver module 602. After the door-opening code is confirmed by the multi-media processor 200 of the doorbell device 2, the multi-media processor 200 will send a high voltage to the relay 208, and then the relay 208 will send a high current/voltage to open the gate 210. Additionally, the firmware to perform the aforementioned procedure is stored in the memory 212, 612 separately.

In another application of the system of the present invention, when an uncertain object passes through the monitored region of the PIR sensor 420 of the detective device 4, the PIR sensor 420 will send a triggering signal to the multi-media processor 400, and then the triggered multi-media processor 400 will start the CMOS sensor 414 and the microphone 416 so that the detective device 4 will become active. The triggered multi-media processor 400 will also send a signal to the RF transceiver module 402, via which the signal is further sent to the RF transceiver module 602 of the portable monitoring device 6. Then, the signal is further transferred to the multi-media processor 600. Once the multi-media processor 600 receives the signal, the monitoring device 6 begins to become active, and an alarm signal is sent to the audio/voice CODEC 604 and transformed into an analog signal, which is then sent to the speaker 618 to generate an alarm sound, and simultaneously the display panel 607 opens, and the monitoring device 6 sends back a signal wirelessly to the detective device 4 to issue a permission for the transmission of an audio-video signal from the detective device 4. Once the multi-media processor 600 receives the audio-video signal from the detective device 4, the image will be displayed on the display panel 607, and the sound will be generated in the speaker 618. Additionally speaking, the firmware of performing the aforementioned procedures is stored in the memory 412, 612 separately.

In yet another application of the system of the present invention, when the house owner presses a select keys 615, the multi-media processor 600 will be triggered to send a wakening signal to the RF transceiver module 602 in order to wake up the detective device 4 via a wireless way, and the display panel 607 and the speaker 618 are also started to operate. Once the detective device 4 is waked up to become active, it will send the audio-video signal to the monitoring device 6 for displaying. If there is some event happening in other devices at the same time, the corresponding link indicator 625 will being flickering in a red light to inform the house owner that there is something waiting for the monitoring device 6 to handle.

The group number 628 of the monitoring device 6 is a number representing the independent wireless network, and via the group number 628, this wireless network can be distinguished from other ones and the interference between those can be avoided. The group number 228 of the doorbell device 2 and the group number 428 of the detective device 4 are also of the same number as that in the monitoring device 6. Inside the network, the monitoring device 2 can identify each of the devices and administrate them via the identify number 229 of the doorbell device 2 and the identify numbers 429 of the detective devices 4. Each of the link indicators 625 on the operating panel indicates the state of the wireless link of the corresponding device separately; when a green light on, it indicates that the state of the wireless link is well; when a red light on, it indicates that the link is being undertaken; when the lights off, it indicates that the link is shut. The doorbell device 2 or the detective device 4 also has its own link indicators 225 or 425 separately; when a green light on, it indicates that the state of the wireless link is well; when a red light on, it indicates that the link is being undertaken; when the lights off, it indicates that the link with the wireless network is shut. Additionally, each device has its own power indicator 222, 422 or 622 separately; when a green light on, it indicates that the device is standing by; when a red light on, it indicates that the device is active; when the lights off, it indicates that the device is off.

Via the utilization of the aforementioned client-server architecture of the present invention, the monitoring device monitors and administrates the doorbell device and the detective devices positioned at the monitored regions. As the center of monitoring and administration, the monitoring device of the present invention utilizes a wireless method to transfer signals, instructions and audio-video data. Further, the operating interface of the monitoring device comprises only simplified keys, and the monitoring system can be used easily by a user who has no knowledge of the way however the system physically operates. Furthermore, the installation and maintenance of the system of the present invention is simple and easy. Accordingly, the present invention improves the drawback of the conventional doorbell device that the function thereof is too simple, and provides a wireless audio-video doorbell monitoring system, which is not only of more functions but also more easily installed, operated and maintained and without the complexity of a wired monitoring system, for a general family usage in order to secure the safety thereof.

Via the embodiments, those described above are to clarify the characteristics of the present invention in order to enable persons skilled in the art to understand, make and use the present invention. It is not intended to limit the scope of the present invention. Any equivalent modification and variation without departing from the spirit disclosed by the present invention is to be included within the scope of the appended claims stated below.

What is claimed is:

1. A wireless audio-video doorbell monitoring system, which provides a detection of the image and sound of monitored regions in order to secure the safety of the monitored regions, and which has at least one entrance positioned at said monitored regions and has a doorbell function, comprising:
at least one doorbell device, positioned at said entrance;
a plurality of detective devices, positioned at said monitored regions and detecting the image and sound of said monitored regions; and
a monitoring device, connecting with said doorbell device and said detective devices via a wireless transmission, administrating said doorbell device and said detective devices and receiving the audio and video signal from said doorbell device and said detective devices via the wireless transmission.

2. The wireless audio-video doorbell monitoring system according to claim 1, wherein said doorbell device further includes: a doorbell unit, which generates a bell ring as a conversation request signal, a wireless receiving/transmitting module, which sends and receives a wireless signal, an image-taking unit, which takes the image of a person, an audio frequency/voice encoding/decoding unit, which encodes the analog audio signal and decodes the digital audio signal, a microphone, which sends the signal of sound, a speaker, which receives the signal of sound and a multi-media processor, which connects with said doorbell unit, said wireless receiving/transmitting module, said image-taking unit and said audio frequency/voice encoding/decoding unit, and processes the digital audio and video signal.

3. The wireless audio-video doorbell monitoring system according to claim 2, wherein said doorbell device connects with an electrically-controlled door.

4. The wireless audio-video doorbell monitoring system according to claim 2, wherein said doorbell device further includes a relay, which controls said electrically-controlled door to open or close, and connects with said multi-media processor to receive the control signal therefrom.

5. The wireless audio-video doorbell monitoring system according to claim 2, wherein said image-taking unit of said doorbell device or said detective devices is an image sensor of complementary metal oxide semiconductor (CMOS).

6. The wireless audio-video doorbell monitoring system according to claim 2, wherein a memory is installed in each of said doorbell device, said detective devices and said monitoring device in order to store programs and data accessed by said multi-media processor.

7. The wireless audio-video doorbell monitoring system according to claim 1, wherein each of said detective devices further includes: a microphone, which receives the signal of sound, an image-taking unit, which takes the image of the surroundings, a sensor, which can sense a moving object, a wireless receiving/transmitting unit, which sends and receives a wireless signal, an audio frequency/voice encoding/decoding unit, which encodes the analog audio signal and decodes the digital audio signal, and a multi-media processor, which connects said image-taking unit, said sensor, said wireless receiving/transmitting module and said audio frequency/voice encoding/decoding unit, and processes the digital audio and video signal.

8. The wireless audio-video doorbell monitoring system according to claim 7, wherein said sensor is a passive infrared reflective sensor (PIR sensor).

9. The wireless audio-video doorbell monitoring system according to claim 7, wherein said image-taking unit of said doorbell device or said detective devices is an image sensor of complementary metal oxide semiconductor (CMOS).

10. The wireless audio-video doorbell monitoring system according to claim 7, wherein a memory is installed in each of said doorbell device, said detective devices and said monitoring device in order to store programs and data accessed by said multi-media processor.

11. The wireless audio-video doorbell monitoring system according to claim 1, wherein said monitoring device further includes: a plurality of select buttons, via which the user can determines which one of said doorbell device or said detective devices is to be linked, a display panel, which shows the images of the monitored regions, a wireless receiving/transmitting module, which sends and receives a wireless signal, an audio frequency/voice encoding/decoding unit, which encodes the analog audio signal and decodes the digital audio signal, a microphone, which sends the signal of sound, a speaker, which receives the signal of sound and a multi-media processor, which connects with said display panel, said select buttons, said wireless receiving/transmitting module and said audio frequency/voice encoding/decoding unit, and processes the digital audio and video signal, and receives the instruction from said select buttons to determine which image from said doorbell device or said detective devices is to be shown on said display panel.

12. The wireless audio-video doorbell monitoring system according to claim 11, wherein said monitoring device further comprises a door lock switching button connecting with said multi-media processor.

13. The wireless audio-video doorbell monitoring system according to claim 11, wherein said display panel is selected from a set of liquid crystal display panel (LCD), organic light emitting diode (OLED) display panel and continuous grain silicon LCD (CGSilicon LCD) display panel.

14. The wireless audio-video doorbell monitoring system according to claim 11, wherein a memory is installed in each of said doorbell device, said detective devices and said monitoring device in order to store programs and data accessed by said multi-media processor.

15. The wireless audio-video doorbell monitoring system according to claim 1, wherein the frequency adopted by said wireless transmission is a 2.4 GHz ISM (industry, science, medicine) frequency band.

16. The wireless audio-video doorbell monitoring system according to claim 1, wherein said monitoring device further comprises a plurality of link indicators.
